(19) United States
(12) Patent Application Publication
(10) Pub. No.: US 2022/0179231 A1
(43) Pub. Date: Jun. 9, 2022

(54) PHOTOGRAPHING APPARATUS AND ELECTRONIC DEVICE

(71) Applicant: Changzhou AAC Raytech Optronics Co., Ltd., Changzhou City (CN)

(72) Inventors: Tianheng Ni, Shenzhen (CN); Feng Yan, Shenzhen (CN); Suohe Wei, Shenzhen (CN)

(21) Appl. No.: 17/541,292

(22) Filed: Dec. 3, 2021

(30) Foreign Application Priority Data
Dec. 8, 2020 (CN) 202011423136.5

(51) Int. Cl. G02B 27/64; G02B 7/02; G03B 5/00; H01F 7/08

(52) U.S. Cl. CPC G02B 27/646; G02B 7/02; G03B 2205/0069; H01F 7/081; G03B 2205/0007; G03B 5/00

(57) ABSTRACT

A photographing apparatus and an electronic device are provided. The photographing apparatus includes a frame assembly, a first movement assembly, first support members, a second movement assembly, second support members, and a lens module. The frame assembly is provided with a receiving cavity. The first movement assembly is suspended in the receiving cavity, and a movement cavity is provided inside the first movement assembly. The first support members are each arranged at least partially in a respective first movement groove and abut against the first movement assembly and the frame assembly. The first movement grooves adapted to the first movement assembly and the second movement grooves adapted to the second movement assembly are provided such that the photographing apparatus is of a compact structure on condition that the lens module can rotate about the first axis of rotation and/or the second axis of rotation.

### TECHNICAL FIELD

The present invention relates to the technical field of photographing apparatuses, and in particular to a photographing apparatus and an electronic device.

### BACKGROUND

Photographing apparatuses are widely used in cameras, mobile phones, tablets, laptops, and other portable electronic devices. Optical Image Stabilization (OIS) apparatuses aim to compensate for camera shake, that is, the vibration of a camera device usually caused by the movement of hands of a user. The vibration degrades the quality of images captured by image sensors. However, the conventional image stabilization apparatuses have a relatively large thickness, and will increase the overall size of the photographing apparatus after being combined with the photographing apparatus, which is not conducive to the lightweight design of the electronic device.

Therefore, there is a need to design a novel photographing apparatus to change the status quo.

### SUMMARY

In view of this, the present invention provides a photographing apparatus and an electronic device, which are used for solving the problem of a large size of the conventional photographing apparatus with an image stabilization apparatus.

The present invention provides a photographing apparatus, including:

a frame assembly provided with a receiving cavity;

a first movement assembly suspended in the receiving cavity, a movement cavity being provided inside the first movement assembly;

a plurality of first support members abutting against the first movement assembly and the frame assembly, such that the first movement assembly is rotatable about a first axis of rotation relative to the frame assembly;

a second movement assembly suspended in the movement cavity;

a plurality of second support members abutting against the second movement assembly and the first movement assembly, such that the second movement assembly is rotatable about a second axis of rotation relative to the first movement assembly, the second axis of rotation being perpendicular to the first axis of rotation; and

a lens module connected to the second movement assembly, the first axis of rotation and the second axis of rotation being both perpendicular to an optical axis of the lens module.

In some embodiments of the present invention, The photographing apparatus further includes a coil group and a magnet group, where the magnet group is fixed to either one of the second movement assembly and the frame assembly, and the coil group is fixed to the other one of the second movement assembly and the frame assembly; and the coil group is used for driving the magnet group to move, so as to drive the lens module to rotate about the first axis of rotation and/or the second axis of rotation relative to the frame assembly.

In some embodiments of the present invention, the coil group includes a first driving coil and a second driving coil, where the first driving coil and the second driving coil are connected to an external circuit and are fixed to the frame assembly; the magnet group includes a first magnet and a second magnet, where the first magnet and the second magnet are both fixed to the second movement assembly and are positioned on two adjacent sides of the first movement assembly; and the first magnet corresponds to the first driving coil, and the second magnet corresponds to the second driving coil.

In some embodiments of the present invention, each of the first support members is a spherical structure, and/or each of the second support members is a spherical structure.

In some embodiments of the present invention, in an extending direction of the optical axis, one side of the frame assembly is provided with a plurality of first movement grooves communicating with the receiving cavity, and the first movement assembly is at least partially suspended in the first movement grooves; and in the extending direction of the optical axis, one side of the first movement assembly is provided with a plurality of second movement grooves communicating with the movement cavity, and the second movement assembly is at least partially suspended in the second movement grooves.

In some embodiments of the present invention, the first movement assembly includes a first movement holder and a plurality of first flexible connection members, where the first movement holder is suspended in the receiving cavity and is at least partially received in the first movement grooves; and the first flexible connection members are connected to the first movement holder and the frame assembly separately, and are fixed to the side of the first movement holder away from the first support members.

In some embodiments of the present invention, the first movement holder is provided with a first movement holder body and a plurality of two first extension portions connected to the first movement holder body, where the two first extension portions are located on two opposite sides of the first movement holder body, and both extend in a direction parallel to the first axis of rotation; the first movement holder body is suspended in the receiving cavity, and each of the first extension portions is received in the respective first movement groove and is arranged spaced apart from an inner wall of the first movement groove; and in the extending direction of the optical axis of the lens module, each of the first support members abuts against a respective first extension portion and the frame assembly.

In some embodiments of the present invention, the inner wall of each of the first movement grooves is provided with a first positioning groove, and an inner wall of the first positioning groove abuts against the respective first support member; and each of the first extension portions is provided with a second positioning groove, and an inner wall of the second positioning groove abuts against the side of the respective first support member away from the respective first positioning groove.

In some embodiments of the present invention, the first positioning grooves and/or the second positioning grooves have a V-shaped cross-section in a direction perpendicular to the first axis of rotation.

In some embodiments of the present invention, the second movement assembly includes a second movement holder and a plurality of second flexible connection members, where the second movement holder is suspended in the movement cavity and is at least partially received in the second movement grooves; and the second flexible connection members are connected to the second movement holder and the first movement assembly separately, and are fixed to the side of the second movement holder away from the second support members.

In some embodiments of the present invention, the second movement holder has a second movement holder body and a plurality of two second extension portions connected to the second movement holder body, where the two second extension portions are located on two opposite sides of the second movement holder body, and both extend in a direction parallel to the second axis of rotation; the second movement holder body is suspended in the movement cavity, and each of the second extension portions is received in the respective second movement groove and is arranged spaced apart from an inner wall of the second movement groove; and in the extending direction of the optical axis of the lens module, each of the second support members abuts against a respective second extension portion and the first movement assembly.

In some embodiments of the present invention, the inner wall of each of the second movement grooves is provided with a third positioning groove, and an inner wall of the third positioning groove abuts against the respective second support member; and each of the second extension portions is provided with a fourth positioning groove, and an inner wall of the fourth positioning groove abuts against the side of the respective second support member away from the respective third positioning groove.

In some embodiments of the present invention, the third positioning grooves and/or the fourth positioning grooves have a V-shaped cross-section in a direction perpendicular to the second axis of rotation.

The present invention further provides an electronic device, including the photographing apparatus described in any one of the above embodiments.

The embodiments of the present invention have the following beneficial effects.

In the photographing apparatus of the embodiments, the first movement assembly is suspended in the receiving cavity of the frame assembly, and a movement cavity for receiving the second movement assembly is provided in the first movement assembly. The first movement assembly and the frame assembly can rotate about the first axis of rotation relative to the frame assembly under the action of the first support members, and the second movement assembly and the first movement assembly can rotate about the second axis of rotation relative to the first movement assembly under the action of the second support members. In the photographing apparatus of the embodiments, the first movement assembly cooperates with the second movement assembly and the frame assembly by means of the second support members and the first support members, so as to form a floating-type double-layer nested structure. The photographing apparatus can have a compact structure on condition that the lens module is rotatable about the first axis of rotation and/or the second axis of rotation, so that the overall size of the photographing apparatus is reduced.

### BRIEF DESCRIPTION OF DRAWINGS

In order to illustrate more clearly embodiments of the present invention or technical schemes in the related art, the accompanying drawings used in description of the embodiments or the related art will be briefly described below, and obviously, the accompanying drawings in the following description are only some embodiments of the present invention, and for those of ordinary skill in the art, other drawings can be derived on the basis of these drawings without any inventive effort.

In the accompanying drawings:

FIG. 1 is a schematic view of an electronic device according to an embodiment of the present invention;

FIG. 2 is a schematic view of a photographing apparatus according to an embodiment of the present invention;

FIG. 3 is a schematic view of the internal structure of a photographing apparatus according to an embodiment of the present invention;

FIG. 4 is a schematic view of a partial structure of a photographing apparatus according to an embodiment of the present invention;

FIG. 5 is a schematic sectional view of a partial structure of a photographing apparatus according to an embodiment of the present invention;

FIG. 6 is a schematic partial sectional view of a photographing apparatus according to an embodiment of the present invention;

FIG. 7 is a schematic partial sectional view of a photographing apparatus according to another embodiment of the present invention;

FIG. 8 is a schematic view of the arrangement of a drive apparatus according to an embodiment of the present invention;

FIG. 9 is a schematic view of the structure of a coil group according to an embodiment of the present invention; and

FIG. 10 is an exploded view of a photographing apparatus according to an embodiment of the present invention.

In the accompanying drawings:
1. Electronic device;
10. Photographing apparatus;
100. Frame assembly; 110. Outer frame; 111. Receiving cavity; 112. First movement groove; 113. First positioning groove; 114. First positioning protrusion; 120. Upper shell; 130. Bottom plate;
200. First movement assembly; 210. First movement holder; 211. First movement holder body; 2111. Movement cavity; 2112. Second movement groove; 2113. Third positioning groove; 2114. Third positioning protrusion; 212. First extension portion; 2121. Second positioning groove; 2122. Second positioning protrusion; 220. First flexible connection member; 2201. First fixing portion; 2202. First flexible portion; 2203. First connection portion;
300. First support member;
400. Second movement assembly; 410. Second movement holder; 411. Second movement holder body; 4111. Mounting cavity; 4112. Fourth positioning protrusion; 412. Second extension portion; 4121. Fourth positioning groove; 420. Second flexible connection member; 4201. Second fixing portion; 4202. Second flexible portion; 4203. Second connection portion;
500. Second support member;
600. Driving module; 610. Coil group; 611. First driving coil; 612. Second driving coil; 613. First circuit board; 620. Magnet group; 621. First magnet; 622. Second magnet;
700. Lens module; 710. Lens unit; 720. Second circuit board; 730. BTB connector;
20. Housing.

### DETAILED DESCRIPTION

The technical schemes in the embodiments of the present invention are clearly and completely described in the following with reference to the drawings in the embodiments of the present invention. It is obvious that the described embodiments are only some of the embodiments of the present invention and are not all the embodiments. All other embodiments obtained by those of ordinary skill in the art based on the embodiments of the present invention without inventive effort shall fall within the scope of the present invention.

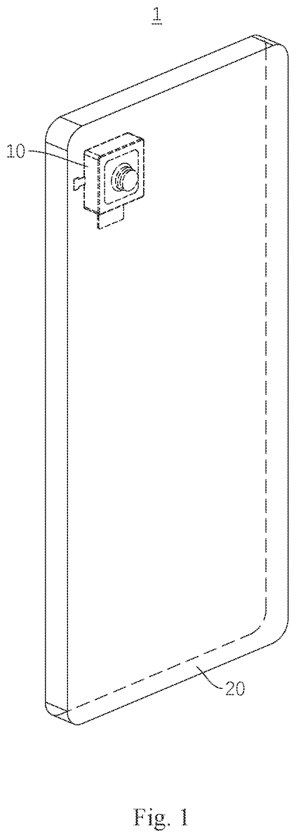

Referring to FIG. 1, an embodiment of the present invention provides an electronic device 1, including a photographing apparatus 10 and a housing 20. The housing 20 serves as a mounting carrier for having the photographing apparatus 10 fixedly mounted. Specifically, the electronic device 1 includes, but is not limited to, a mobile phone, a tablet computer, a television, a gaming console, etc., which can be provided with the photographing apparatus 10, and is not uniquely limited here.

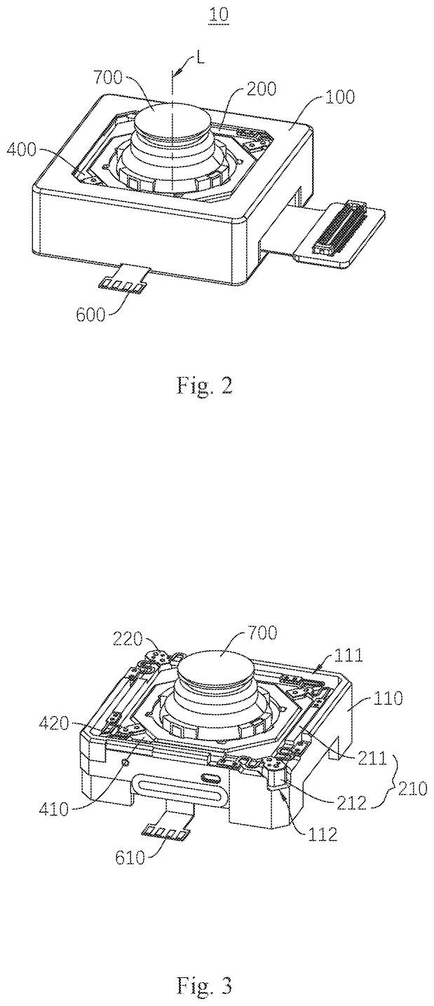

Specifically, as shown in FIGS. 2-5, the photographing apparatus 10 includes a frame assembly 100, a first movement assembly 200, first support members 300, a second movement assembly 400, second support members 500, and a lens module 700. The frame assembly 100 serves as a bearing base and is provided with a receiving cavity 111, and an inner wall of the receiving cavity 111 is provided with first movement grooves 112 communicating with the receiving cavity 111. The first movement assembly 200 is suspended in the receiving cavity 111 and is at least partially received in the first movement grooves 112. The first movement assembly 200 is internally provided with a movement cavity 2111, and an inner wall of the movement cavity 2111 is provided with second movement grooves 2112 communicating with the movement cavity 2111. The first support members 300 are each arranged at least partially in a respective first movement groove 112 and each abut against the first movement assembly 200 and the frame assembly 100, such that the first movement assembly 200 can rotate about a first axis of rotation relative to the frame assembly 100. The second movement assembly 400 is suspended in the movement cavity 2111 and is at least partially received in the second movement grooves 2112. The second support members 500 are each arranged at least partially in a respective second movement groove 2112 and abut against the first movement assembly 200 and the second movement assembly 400, such that the second movement assembly 400 can rotate about a second axis of rotation relative to the first movement assembly 200. An included angle is formed between the first axis of rotation and the second axis of rotation. The lens module 700 is fixed to the second movement assembly 400.

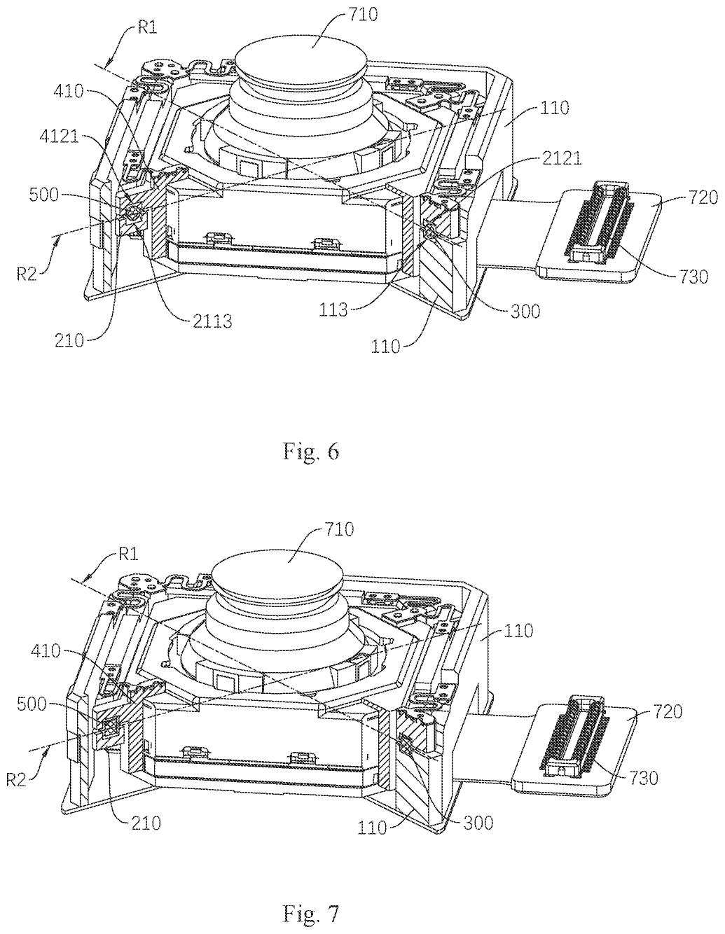

In the photographing apparatus 10 of this embodiment, the first movement assembly 200 is suspended in the receiving cavity 111 of the frame assembly 100, and a movement cavity 2111 for receiving the second movement assembly 400 is provided in the first movement assembly 200. The first movement assembly 200 and the frame assembly 100 can rotate about the first axis of rotation relative to the frame assembly 100 under the action of the first support members 300, and the second movement assembly 400 and the first movement assembly 200 can rotate about the second axis of rotation relative to the first movement assembly 200 under the action of the second support members 500. In the photographing apparatus 10 of this embodiment, the first movement assembly 200 cooperates with the second movement assembly 400 and the frame assembly 100 by means of the second support members 500 and the first support members 300, so as to form a floating-type double-layer nested structure. The photographing apparatus 10 can have a compact structure on condition that the lens module 700 is rotatable about the first axis of rotation and/or the second axis of rotation, so that the overall size of the photographing apparatus 10 is reduced. It should be noted that referring to FIG. 1, L is defined as the optical axis of the lens module 700, and referring to FIGS. 6 and 7, R1 is defined as the first axis of rotation and R2 is defined as the second axis of rotation.

Specifically, as shown in FIG. 3, the first movement assembly 200 includes a first movement holder 210 and first flexible connection members 220. The first movement holder 210 is suspended in the receiving cavity 111 and is at least partially received in the first movement grooves 112. Each of the first flexible connection members 220 is connected to the first movement holder 210 and the frame assembly 100 separately.

With this arrangement, when the first movement assembly 200 rotates about the first axis of rotation under the action of an external force, the first flexible connection members 220 are deformed and store elastic potential energy, and when the external force is removed, the first flexible connection members 220 release the elastic potential energy and drive the first movement assembly 200 to reset.

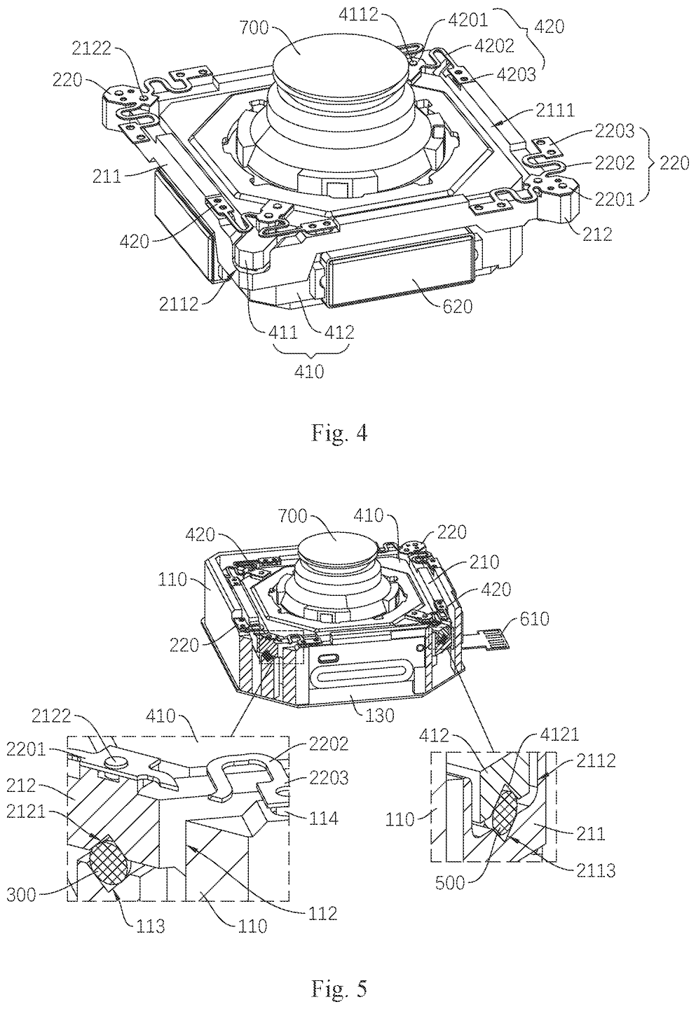

Referring to FIG. 4, in an embodiment, each of the first flexible connection members 220 has a first fixing portion 2201, first flexible portions 2202 and first connection portions 2203. The first fixing portion 2201 is fixed to the first movement holder 210, the first connection portions 2203 are fixed to the frame assembly 100, and the first flexible portions 2202 are each connected to both the first fixing portion 2201 and the first connection portion 2203. The number of first flexible portions 2202 and the number of first connection portions 2203 are both two, and they are both symmetrically arranged on two opposite sides of the first fixing portion 2201.

Specifically, in this embodiment, each of the first flexible portions 2202 is bent back at least twice in a direction from the first fixing portion 2201 to the respective first connection portion 2203, so that the first flexible connection member 220 has a larger deformation space. The arrangement of two sets of first flexible portions 2202 and first connection portions 2203 on the two sides of the first fixing portion 2201 can provide stable elastic support and reset for the first movement holder 210. Optionally, the projections of the two sets of first flexible portions 2202 and first connection portions 2203 on the first fixing portion 2201 along the optical axis of the lens module 700 is symmetrical about the first axis of rotation, so that the first flexible connection members 220 can provide uniform restoring force during the reverse or forward rotation of the first movement assembly 200 about the first axis of rotation.

Specifically, the projection of the first support member 300 on the respective first fixing portion 2201 along the optical axis of the lens module 700 at least partially overlaps with the first fixing portion 2201.

With this arrangement, after the photographing apparatus 10 is assembled, the first fixing portion 2201 of each of the first flexible connection members 220 can exert an elastic action force on the respective first support member 300 in the extending direction of the optical axis, such that the first movement holder 210 is closely attached to the first support member 300, thereby preventing the first movement holder 210 from jumping in the extending direction of the optical axis, and improving the running stability of the photographing apparatus 10.

Specifically, in an embodiment, the first movement holder 210 is provided with a first movement holder body 211 and two first extension portions 212 connected to the first movement holder body. The two first extension portions 212 are located on two opposite sides of the first movement holder body 211, and the two first extension portions 212 both extend in a direction parallel to the first axis of rotation. The first movement shelf body 211 is suspended in the receiving cavity 111, and each of the first extension portions 212 is received in the respective first movement groove 112 and is arranged spaced apart from an inner wall of the first movement groove 112. Referring to FIG. 5, in the extending direction of the optical axis of the lens module 700, each of the first support members 300 abuts against a respective first extension portion 212 and the frame assembly 100.

It can be understood that, in this embodiment, since the two first extension portions 212 both extend along the direction of the first axis of rotation, a connecting line between the two first extension portions 212 is parallel to the first axis of rotation. Since the first support members 300 each abut against the frame assembly 100 and the respective first extension portion 212, the first movement holder 210 can be completely separated from the frame assembly 100 after assembly and is suspended in the receiving cavity 111. The first movement assembly 200 and the frame assembly 100 are only supported by the first support members 300, which enables the first movement holder 210 to rotate about the first axis of rotation in the frame assembly 100, and also enables the photographing apparatus 10 to have a more compact structure.

Referring to FIG. 5, in an embodiment, the inner wall of each of the first movement grooves 112 is provided with a first positioning groove 113, and an inner wall of the first positioning groove 113 abuts against the respective first support member 300. Each of the first extension portions 212 is provided with a second positioning groove 2121, and an inner wall of the second positioning groove 2121 abuts against the side of the respective first support member 300 away from the respective first positioning groove 113.

The first positioning groove 113 and the second positioning groove 2121 are arranged to cooperate with the respective first support member 300, so that the movement of the first support member 300 can be limited on the premise of realizing the rotation function of the first movement assembly 200. Specifically, in this embodiment, there are two sets of first positioning grooves 113, second positioning grooves 2121 and first support members 300, which are arranged on two opposite sides of the first movement holder body 211 in the extending direction of the first axis of rotation. With this arrangement, the connecting line between the two first support members 300 is the first axis of rotation.

Specifically, in this embodiment, in the extending direction of the optical axis, the upper side of each of the first movement grooves 112 is provided with an opening, that is to say, in the process of assembling the first movement assembly 200, the respective first extension portion 212 can be mounted into the first movement groove 112 through the upper side opening of the first movement groove 112. In other embodiments, the upper side of the first movement groove 112 may alternatively be closed. With this arrangement, the first extension portion 212 is inserted into the first movement groove 112 after the photographing apparatus 10 is assembled.

Referring to FIG. 5, specifically, in an embodiment, the first positioning grooves 113 and/or the second positioning grooves 2121 have a V-shaped cross-section in a direction perpendicular to the first axis of rotation. By setting the positioning grooves to be V-shaped, after the photographing apparatus 10 is assembled, an outer wall of each of the first support members 300 abuts against two side walls of the respective V-shaped groove, thereby limiting the degrees of freedom of the first movement holder 210 except the degree of freedom of rotation about the first axis of rotation.

Referring to FIG. 4, in an embodiment, each of the first flexible connection members 220 has a first fixing portion 2201, first flexible portions 2202 and first connection portions 2203. The first fixing portion 2201 is fixed to a respective first extension portion 212, the first connection portions 2203 are fixed to the frame assembly 100, and the first flexible portions 2202 are each connected to both the first fixing portion 2201 and the first connection portion 2203.

With this arrangement, when the first flexible connection member 220 exerts an elastic force on the first movement holder 210, the first fixing portion 2201 can directly act on the first extension portion 212, so that the first movement assembly 200 has a more compact structure on the premise that the first movement holder 210 can rotate.

Referring to FIG. 5, the first flexible connection members 220 are fixed to the side of the first movement holder 210 away from the first support members 300. With this arrangement, after the first flexible connection members 220 are connected and fixed to the first movement holder 210 and the frame assembly 100, the first flexible connection members 220 can exert elastic forces toward the first movement holder 210 to limit the first support members 300 between the first movement holder 210 and the frame assembly 100.

In this embodiment, there are two first flexible connection members 220, and the two first flexible connection members 220 are symmetrically arranged on two opposite sides of the first movement holder 210, and the connecting line between the two first flexible connection members 220 is parallel to the first axis of rotation.

Specifically, referring to FIGS. 3 and 4, the second movement assembly 400 includes a second movement holder 410 and second flexible connection members 420. The second movement holder 410 is suspended in the movement cavity 2111 and is at least partially received in the second movement grooves 2112. The second flexible connection members 420 are each connected to both the second movement holder 410 and the first movement assembly 200.

With this arrangement, when the second movement assembly 400 rotates about the second axis of rotation under the action of an external force, the second flexible connection members 420 are deformed and store elastic potential energy, and when the external force is removed, the second flexible connection members 420 release the elastic potential energy and drive the second movement assembly 400 to reset.

Referring to FIG. 4, in an embodiment, each of the second flexible connection members 420 has a second fixing portion 4201, second flexible portions 4202 and second connection portions 4203. The second fixing portion 4201 is fixed to the second movement holder 410, the second connection portions 4203 are fixed to the first movement assembly 200, and the second flexible portions 4202 are each connected to both the second fixing portion 4201 and the second connection portion 4203. The number of second flexible portions 4202 and the number of second connection portions 4203 are both two, and they are symmetrically arranged on two opposite sides of the second fixing portion 4201.

Specifically, in this embodiment, each of the second flexible portions 4202 is bent back at least twice in a direction from the second fixing portion 4201 to the respective second connection portion 4203, so that the second flexible connection member 420 has a larger deformation space. The arrangement of two sets of second flexible portions 4202 and second connection portions 4203 on the two sides of the second fixing portion 4201 can provide stable elastic support and reset for the second movement holder 410. Optionally, the projections of the two sets of second flexible portions 4202 and second connection portions 4203 on the second fixing portion 4201 along the optical axis of the lens module 700 is symmetrical about the second axis of rotation, so that the second flexible connection members 420 can provide uniform restoring force during the reverse or forward rotation of the second movement assembly 400 about the second axis of rotation.

Specifically, in an embodiment, the second movement holder 410 has a second movement holder body 411 and two second extension portions 412 connected to the second movement holder body. The two second extension portions 412 are located on two opposite sides of the second movement holder body 411, and the two second extension portions 412 both extend in a direction parallel to the second axis of rotation. The second movement holder body 411 is suspended in the movement cavity 2111, and each of the second extension portions 412 is received in the respective second movement groove 2112 and is arranged spaced apart from an inner wall of the second movement groove 2112. Referring to FIG. 5, in the extending direction of the optical axis of the lens module 700, each of the second support members 500 abuts against a respective second extension portion 412 and the first movement assembly 200.

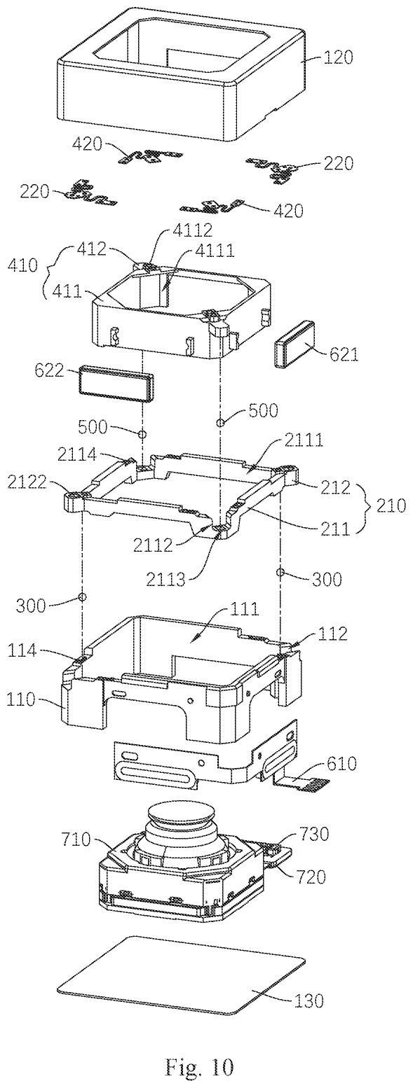

It can be understood that, in this embodiment, since the two second extension portions 412 both extend along the direction of the second axis of rotation, a connecting line between the two second extension portions 412 is parallel to the second axis of rotation. Since the second support members 500 each abut against the first movement assembly 200 and the respective second extension portion 412, the second movement holder 410 can be completely separated from the first movement assembly 200 after assembly and is suspended in the movement cavity 2111. The second movement assembly 400 and the first movement assembly 200 are only supported by the second support members 500, which enables the second movement holder 410 to rotate about the second axis of rotation in the first movement assembly 200, and also enables the photographing apparatus 10 to have a more compact structure. Referring to FIG. 10, a mounting cavity 4111 is provided in the second movement holder body 411, and the lens module 700 is received in the mounting cavity 4111 and is fixed to the second movement holder 410.

Referring to FIG. 5, in an embodiment, the inner wall of each of the second movement grooves 2112 is provided with a third positioning groove 2113, and an inner wall of the third positioning groove 2113 abuts against the respective second support member 500. Each of the second extension portions 412 is provided with a fourth positioning groove 4121, and an inner wall of the fourth positioning groove 4121 abuts against the side of the respective second support member 500 away from the respective third positioning groove 2113.

The third positioning groove 2113 and the fourth positioning groove 4121 are arranged to cooperate with the respective second support member 500, so that the movement of the second support member 500 can be limited on the premise of realizing the rotation function of the second movement assembly 400. Specifically, in this embodiment, there are two sets of third positioning grooves 2113, fourth positioning grooves 4121 and second support members 500, which are arranged on two opposite sides of the second movement holder body 411 in the extending direction of the second axis of rotation. With this arrangement, the connecting line between the two second support members 500 is the second axis of rotation.

Specifically, in this embodiment, in the extending direction of the optical axis, the upper side of each of the second movement grooves 2112 is provided with an opening, that is to say, in the process of assembling the second movement assembly 400, the respective second extension portion 412 can be mounted into the second movement groove 2112 through the upper side opening of the second movement groove 2112. In other embodiments, the upper side of the second movement groove 2112 may alternatively be closed. With this arrangement, the second extension portion 412 is inserted into the second movement groove 2112 after the photographing apparatus 10 is assembled.

Referring to FIG. 5, specifically, in an embodiment, the third positioning grooves 2113 and/or the fourth positioning grooves 4121 have a V-shaped cross-section in a direction perpendicular to the second axis of rotation. By setting the positioning grooves to be V-shaped, after the photographing apparatus 10 is assembled, an outer wall of each of the second support members 500 abuts against two side walls of the respective V-shaped groove, thereby limiting the degrees of freedom of the second movement holder 410 except the degree of freedom of rotation about the second axis of rotation.

Referring to FIGS. 5 and 6, the second flexible connection members 420 are fixed to the side of the second movement holder 410 away from the second support members 500.

With this arrangement, after the second flexible connection members 420 are connected and fixed to the second movement holder 410 and the first movement assembly 200, the second flexible connection members 420 can exert elastic forces toward the second movement holder 410 to limit the second support members 500 between the second movement holder 410 and the first movement assembly 200.

In this embodiment, there are two second flexible connection members 420, and the two second flexible connection members 420 are symmetrically arranged on two opposite sides of the second movement holder 410, and the connecting line between the two second flexible connection members 420 is parallel to the second axis of rotation.

Referring to FIGS. 4, 5 and 10, in an embodiment, the frame assembly 100 is provided with first positioning protrusions 114, and the first movement assembly 200 is provided with second positioning protrusions 2122. The first positioning protrusions 114 are arranged in the first connection portions 2203 in a penetrating manner and are used for positioning the first connection portions 2203, and the second positioning protrusions 2122 are arranged in the first fixing portions 2201 in a penetrating manner and are used for positioning the first fixing portions 2201. The first movement assembly 200 is further provided with third positioning protrusions 2114, and the second movement assembly 400 is provided with fourth positioning protrusions 4112. The third positioning protrusions 2114 are arranged in the second connection portions 4203 in a penetrating manner and are used for positioning the second connection portions 4203, and the fourth positioning protrusions 4112 are arranged in the second fixing portions 4201 in a penetrating manner and are used for positioning the second fixing portions 4201.

Further, referring to FIG. 2, the photographing apparatus 10 further includes a driving module 600. The driving module 600 is fixed to the frame assembly 100 and used for driving the lens module 700 to rotate relative to the first movement assembly 200 and/or the second movement assembly 400.

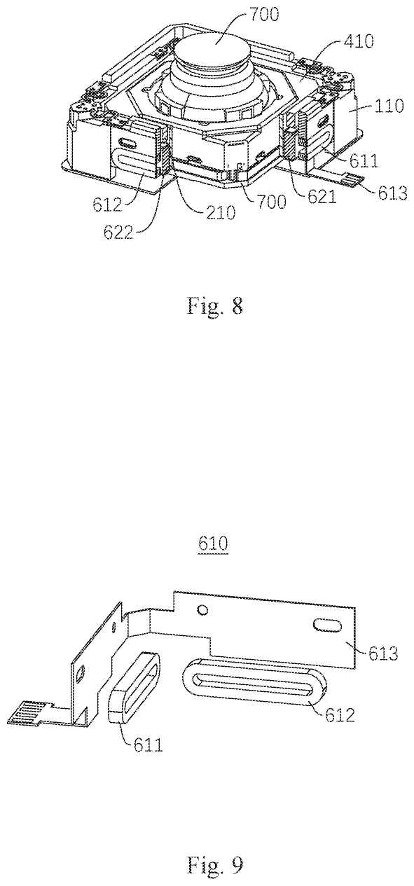

Referring to FIGS. 8-10, in an embodiment, the driving module 600 includes a coil group 610 and a magnet group 620. The magnet group 620 is fixed to either one of the second movement assembly 400 and the frame assembly 100, and the coil group 610 is fixed to the other one of the second movement assembly 400 and the frame assembly 100. The coil group 610 is used for driving the magnet group 620 to move, so as to drive the lens module 700 to rotate about the first axis of rotation and/or the second axis of rotation relative to the frame assembly 100.

Specifically, referring to the embodiments shown in FIG. 4 and FIGS. 8 to 10, the coil group 610 is fixed to the frame assembly 100, and the magnet group 620 is fixed to the second movement assembly 400. In other embodiments, the coil group 610 may alternatively be fixed to the second movement assembly 400, and the magnet group 620 on the frame assembly 100, thereby realizing the driving function of the coil group 610. In some other embodiments, the magnet group 620 may alternatively be fixed to the frame assembly 100 and the second movement assembly 400, and the coil group 610 may be fixed to the frame assembly 100 and/or the second movement assembly 400, so as to realize the driving function of the coil group 610, which is not limited here.

In other embodiments, the magnet group 620 may alternatively be fixed to the lens module 700, and the coil group 610 is connected to an external circuit and used for driving the magnet group 620 to move, so as to drive the lens module 700 to rotate about the first axis of rotation and/or the second axis of rotation relative to the frame assembly 100.

Referring to FIGS. 8 and 9, in an embodiment, the coil group 610 includes a first driving coil 611 and a second driving coil 612. The first driving coil 611 and the second driving coil 612 are connected to an external circuit and are fixed to the frame assembly 100. The magnet group 620 includes a first magnet 621 and a second magnet 622. The first magnet 621 and the second magnet 622 are both fixed to the second movement assembly 400 and are positioned on two adjacent sides of the first movement assembly 200. The first magnet 621 corresponds to the first driving coil 611, and the second magnet 622 corresponds to the second driving coil 612.

Specifically, in this embodiment, the coil group 610 further includes a first circuit board 613. The first driving coil 611 and the second driving coil 612 are both fixed to the first circuit board 613 and electrically connected thereto. One end of the first circuit board 613 extends out of the frame assembly 100 and is used for connecting to an external control circuit.

Specifically, in this embodiment, the frame assembly 100 includes an outer frame 110, an upper shell 120 and a bottom plate 130. The upper shell 120 is connected to the bottom plate 130 and forms a receiving space inside the upper shell 120. The outer frame 110 is fixed to the bottom plate 130 and is received in the receiving space. The receiving cavity 111 is provided inside the outer frame 110.

Referring to FIGS. 6, 7 and 10, in this embodiment, the lens module 700 includes a lens unit 710, a second circuit board 720, and a BTB connector 730 fixed to the second circuit board 720. The second circuit board 720 is electrically connected to both the lens unit 710 and the BTB connector 730. The BTB connector 730 is used for connecting to an external control circuit, and the end of the second circuit board 720 away from the lens unit 710 extends out of the frame assembly 100. The BTB connector 730 is located outside the receiving cavity 111.

Referring to FIGS. 6 and 8, in this embodiment, the first axis of rotation is perpendicular to the second axis of rotation, and the first axis of rotation and the second axis of rotation are both perpendicular to the optical axis of the lens module 700. Specifically, in this embodiment, the first movement holder body 211, the second movement holder body 411 and the outer frame 110 are square, and the first support members 300 and the second support members 500 are separately located at four corners of the square outer frame 110. In other embodiments, the first movement holder body 211, the second movement holder body 411 and the outer frame 110 may alternatively be rectangular or circular, and the included angle between the first axis of rotation and the second axis of rotation is set according to the actual situation.

Referring to FIGS. 6 and 10, in this embodiment, the first support members 300 are spherical, and/or the second support members 500 are spherical. It can be understood that by supporting the spherical first support members 300 and second support members 500 between the frame assembly 100 and the first movement assembly 200 and between the first movement assembly 200 and the second movement assembly 400, respectively, the friction therebetween can be reduced and the supporting effect is good. Referring to FIG. 7, in another embodiment, the first support members 300 and/or the second support members 500 may alternatively be configured in the shape of a cylinder, and the axis of the cylinder coincides with the axis of rotation.

The disclosure above is merely preferred embodiments of the present invention and certainly cannot be used to limit the scope of the present invention. Therefore, equivalent changes made according to the claims of the present invention are still covered by the present application.

What is claimed is:

1. A photographing apparatus, comprising:
a frame assembly provided with a receiving cavity;
a first movement assembly suspended in the receiving cavity, a movement cavity being provided inside the first movement assembly;
a plurality of first support members abutting against the first movement assembly and the frame assembly, such that the first movement assembly is rotatable about a first axis of rotation relative to the frame assembly;
a second movement assembly suspended in the movement cavity;
a plurality of second support members abutting against the second movement assembly and the first movement assembly, such that the second movement assembly is rotatable about a second axis of rotation relative to the first movement assembly, the second axis of rotation being perpendicular to the first axis of rotation; and
a lens module connected to the second movement assembly, the first axis of rotation and the second axis of rotation being both perpendicular to an optical axis of the lens module.

2. The photographing apparatus as described in claim 1, further comprising a coil group and a magnet group, wherein the magnet group is fixed to either one of the second movement assembly and the frame assembly, and the coil group is fixed to the other one of the second movement assembly and the frame assembly; and the coil group is used for driving the magnet group to move, so as to drive the lens module to rotate about the first axis of rotation and/or the second axis of rotation relative to the frame assembly.

3. The photographing apparatus as described in claim 2, wherein the coil group comprises a first driving coil and a second driving coil, wherein the first driving coil and the second driving coil are connected to an external circuit and are fixed to the frame assembly; the magnet group comprises a first magnet and a second magnet, wherein the first magnet and the second magnet are both fixed to the second movement assembly and are positioned on two adjacent sides of the first movement assembly; and the first magnet corresponds to the first driving coil, and the second magnet corresponds to the second driving coil.

4. The photographing apparatus as described in claim 1, wherein each of the first support members is a spherical structure, and/or each of the second support members is a spherical structure.

5. The photographing apparatus as described in claim 1, wherein in an extending direction of the optical axis, one side of the frame assembly is provided with a plurality of first movement grooves communicating with the receiving cavity, and the first movement assembly is at least partially suspended in the first movement grooves; and in the extending direction of the optical axis, one side of the first movement assembly is provided with a plurality of second movement grooves communicating with the movement cavity, and the second movement assembly is at least partially suspended in the second movement grooves.

6. The photographing apparatus as described in claim 5, wherein the first movement assembly comprises a first movement holder and a plurality of first flexible connection members, wherein the first movement holder is suspended in the receiving cavity and is at least partially received in the first movement grooves; and the first flexible connection members are connected to the first movement holder and the frame assembly separately, and are fixed to the side of the first movement holder away from the first support members.

7. The photographing apparatus as described in claim 6, wherein the first movement holder is provided with a first movement holder body and a plurality of two first extension portions connected to the first movement holder body, wherein the two first extension portions are located on two opposite sides of the first movement holder body, and both extend in a direction parallel to the first axis of rotation; the first movement holder body is suspended in the receiving cavity, and each of the first extension portions is received in the respective first movement groove and is arranged spaced apart from an inner wall of the first movement groove; and in the extending direction of the optical axis of the lens module, each of the first support members abuts against a respective first extension portion and the frame assembly.

8. The photographing apparatus as described in claim 7, wherein the inner wall of each of the first movement grooves is provided with a first positioning groove, and an inner wall of the first positioning groove abuts against the respective first support member; and each of the first extension portions is provided with a second positioning groove, and an inner wall of the second positioning groove abuts against the side of the respective first support member away from the respective first positioning groove.

9. The photographing apparatus as described in claim 8, wherein the first positioning grooves and/or the second positioning grooves have a V-shaped cross-section in a direction perpendicular to the first axis of rotation.

10. The photographing apparatus as described in claim 5, wherein the second movement assembly comprises a second movement holder and a plurality of second flexible connection members, wherein the second movement holder is suspended in the movement cavity and is at least partially received in the second movement grooves; and the second flexible connection members are connected to the second movement holder and the first movement assembly separately, and are fixed to the side of the second movement holder away from the second support members.

11. The photographing apparatus as described in claim 10, wherein the second movement holder has a second movement holder body and a plurality of two second extension portions connected to the second movement holder body, wherein the two second extension portions are located on two opposite sides of the second movement holder body, and both extend in a direction parallel to the second axis of rotation; the second movement holder body is suspended in the movement cavity, and each of the second extension portions is received in the respective second movement groove and is arranged spaced apart from an inner wall of the second movement groove; and in the extending direction of the optical axis of the lens module, each of the second support members abuts against a respective second extension portion and the first movement assembly.

12. The photographing apparatus as described in claim 11, wherein the inner wall of each of the second movement grooves is provided with a third positioning groove, and an inner wall of the third positioning groove abuts against the respective second support member; and each of the second extension portions is provided with a fourth positioning groove, and an inner wall of the fourth positioning groove abuts against the side of the respective second support member away from the respective third positioning groove.

13. The photographing apparatus as described in claim 12, wherein the third positioning grooves and/or the fourth positioning grooves have a V-shaped cross-section in a direction perpendicular to the second axis of rotation.

14. An electronic device, comprising the photographing apparatus as described in claim 1.
